(19) United States
(12) Patent Application Publication
(10) Pub. No.: US 2002/0145848 A1
(43) Pub. Date: Oct. 10, 2002

(54) Attachable accessory case for portable computers

(76) Inventor: Norman Anthony Newell, Miami, FL (US)

Correspondence Address: Norman Anthony Newell, 2800 SW Williston Rd App 122C, Gainesville, FL, 32608, US

(21) Appl. No.: 09/832,147

(22) Filed: Apr. 10, 2001

(51) Int. Cl. G06F 1/16

(52) U.S. Cl. 361/683

(57) ABSTRACT

A small, lightweight accessory carrying case for portable computers 13 that is made of a front wall 10, a back wall 1, and edge wall 3,4 combined with closure means 2, and external attachment devices 5, wherein the front, back, and edge walls close to form an inner storage area containing inner compartments 8 seal able by closure devices 7, and sleeved discs sheets 12, affixed by a attachment/holder 11, intended to store portable computer accessories.

### FIELD OF INVENTION

This invention relates to portable computer accessory cases, specifically cases designed to carry compact/computer discs, documents, power cords and other computer accessories.

### DESCRIPTION OF RELATED ART

The functional use of portable computers requires an assortment of accessories. Traditionally, these accessories are transported and protected in either the supplemental compartments of a large carrying case designed to carry the computer itself, or in separate smaller cases wherein accessories such as compact discs are carried separately from the computer and the large computer carrying case. Both casing methods limit the convenience and transportability that is the very nature of portable computers. The former method of transport is flawed because it is cumbersome. Obviously these cases must be large enough so as a portable computer can be transported inside. Furthermore, while a portable computer is being used, the bulky case must be kept near the user to ensure the accessories stored in the case can be accessed. This is a problem in tight spaces such as the aircraft cabins. A person must choose to either keep the case in the sparse legroom area (and in coach there is barely any of it) or in the overhead compartment. In either scenario one will be either uncomfortable or need to repeatedly stand up and sit (to access the overhead bin) down whenever an accessory must be used.

The problem with individual smaller cases is that they must be carried separately. Although smaller than the computer cases, they are an additional item a two handed human is forced to carry. In either instance, the versatility and portability of portable computers is not what it can be.

### BRIEF SUMMARY OF INVENTION

Accordingly, besides the objects and advantages of the attachable carrying case described in my above patent, several objects and advantages of the present invention are:

(a) To allow various accessories related to the use of portable computers to be stored and protected in a casing that is sized and attachable to portable computers.

(b) To allow these accessories to be stored and used on the computer even while it is being used.

(c) To consolidate the portable computer and accessory transporter/protector into one carrying unit, thus eliminating the amount of items to be separately carried.

Still further objects and advantages will become apparent from consideration of the ensuing description and drawings.

### DRAWING FIGURES

In the drawings, each figure serves to show the following:

FIG. 1 shows various aspects of the case including a main view of the underside containing the attachment devices applicable to a portable computer.

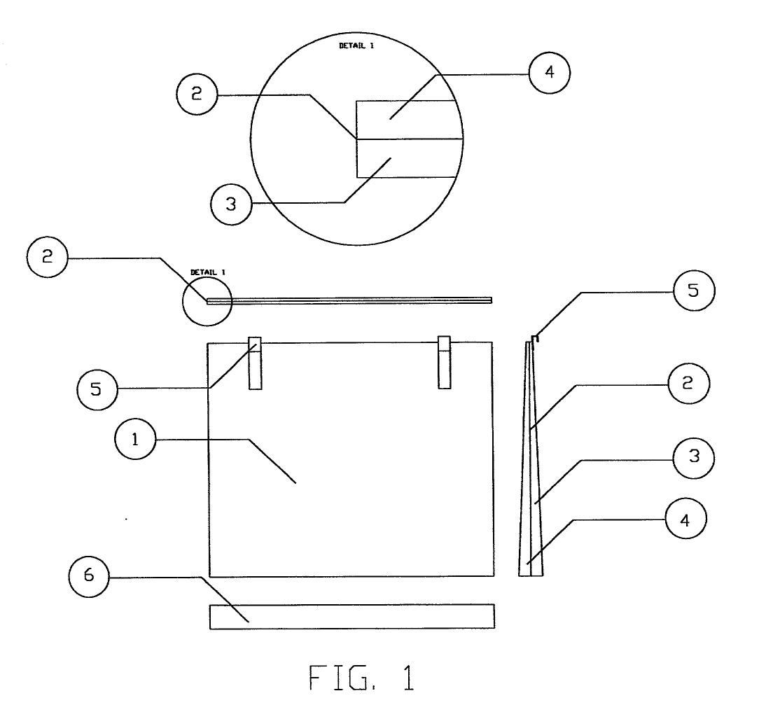

FIG. 2 shows a view of the inside of the case when opened. This view is intended to show the fixed inner parts of the case. To preserve clarity, the sleeved sheet for discs is not included in this view.

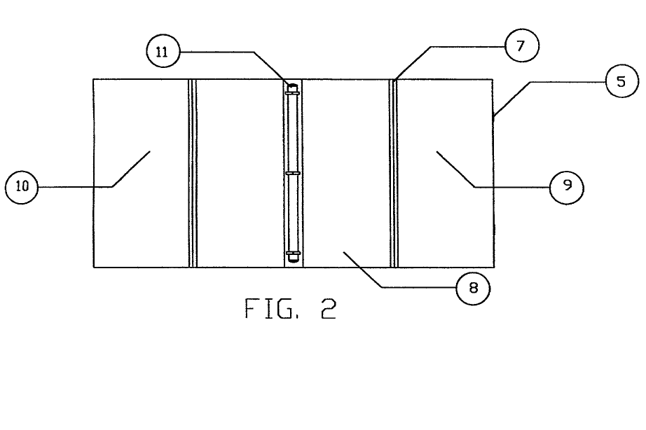

FIG. 3 shows a view similar to FIG. 2. This is the inside of the case, however, this view includes the sleeved sheets for discs.

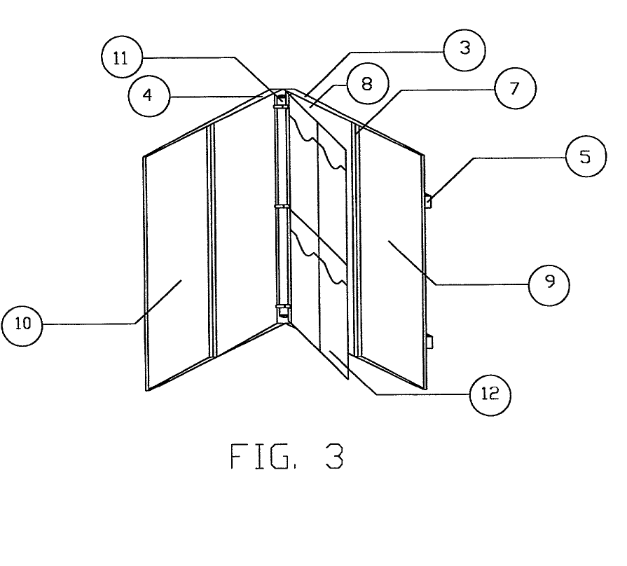

FIG. 4 shows a side view of the case while attached to a portable computer.

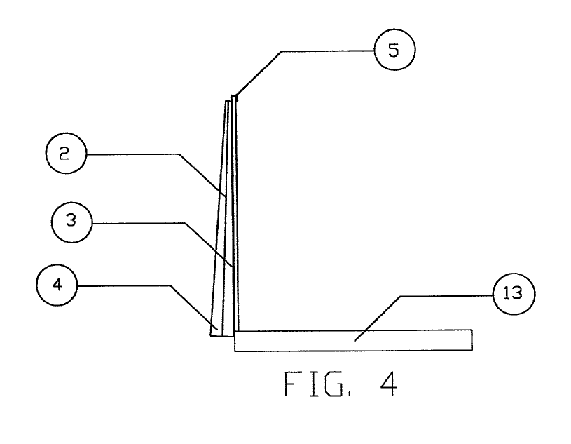

### REFERENCE NUMERALS IN DRAWINGS

1 back wall

2 closure means

3 lower part of edge wall

4 upper part of edge wall

5 exterior attachment device

6 spine

7 access/closure device for inner compartment

8 inner compartment

9 inner side of back wall

10 inner side of front wall

11 attachment/holder for sleeved disc sleeves

12 sleeved disc sheet

13 portable computer

### DESCRIPTION OF FIGURES

The figures in the drawings represent a typical embodiment of the invention. The carrying case has a back wall 1, a front wall 10, and an edge wall 3,4. These walls 1,10,3,4 are made of a semi durable material such as leather. However, alternative materials may be substituted, such as vinyl, canvas, flexible plastic (e.g. poly-ethylene-tere-phthalate), cardboard, various laminated materials, etc. The edge wall 3,4 has a closure means 2 attached to it, such as a zipper. However, alternative closure means can be used, such as hooks, buttons, interlocking grooves, magnets, etc. The front and back walls 1,10 are joined at a common end to make a spine 6. This spine 6 allows for the front and back walls to open and close in a hinged fashion, comparable to a book. Attached to the back wall 1 are one or more exterior attachment devices 5 (the drawings show two). The attachment device 5 can be a hook, sleeve, magnet, Velcro, etc. The attachment device 5 is what will attach the carrying case to the portable computer 13. This attachment device may be sizable for use on one or more different portable computers. The walls 1,10,3,4 combined with the closure means close to form a storage area inside wherein the space can be used to store various portable computer accessories, e.g. diskettes, compact discs, writing implements, paper, etc. Formed inside the front and back walls 1,10 are inner compartments 8 where accessories may be stored. The inner compartments are seal able by means of a closure device 7, similar to that of the closure means 2 used to join the front, back and edge walls 10,1,3,4. Along the inner side of the spine 6 is an attachment/holding device 11 used to hold sleeved disc sheets 12. The attachment/holding device 11 is preferably a tri-ringed binding device such as those found in notebooks. However alternative attachment devices may be used (even adhesives will work). The sleeved disc sheets 12 may be made of cloth, flexible plastic, cardboard, etc. Any one or combination of these materials may be used to make the disc sheet 12.

### SUMMARY, RAMIFICATIONS, and SCOPE

Accordingly, the reader will see that the attachable accessory case for a portable computer allows for optimum convenience. By nature, portable computers are tools of expediency and portability, elements that are optimized by this invention most simply by, consolidating the portable computer and accessory case into one carrying entity.

The invention is rather simple and inexpensive to make. Although the description above contains much specificity, these should not be construed as limiting the scope of the invention but as merely providing illustrations of a preferred embodiment of this invention. In addition dimensions of the invention are omitted because the size is determined by the size of the portable computer the invention is intended to be used in conjunction with. Many alternative construction materials and methods, other than those stated above may be used at the manufacturers consent.

Thus the scope of the invention must be determined by the appended claims and their legal equivalents, rather than by the examples given.

I claim:

1. A carrying case for protectively carrying portable computer accessories and work accessories where said case is attachable to a portable computer.

2. A carrying case for protectively carrying portable computer accessories and work accessories where said case is attachable to the top screen component of a portable computer.

3. A carrying case for protectively carrying portable computer disks, compact disks, pens, pencils, and papers comprising a durable front wall, a durable back wall, and durable edge wall perpendicularly connecting the front and back wall wherein a closure means is provided integral with the edge wall for opening or closing a storage compartment formed between the front and back wall said compartment capable of protectively storing portable computer accessories within said walls, said carrying case containing one or more exterior attachment devices whereas said carrying case can be attached to the top screen component of the portable computer.

4. The carrying case of claim 3, wherein the attachment devices on the back wall of the case do not make contact with the viewing screen.

5. The carrying case of claim 3, wherein the attachment devices on the back wall of the case are adjustable in gripping size.

6. The carrying case of claim 3, wherein the diameter of the front and back walls is equal to or smaller than that of the top screen component of a portable computer.

7. The carrying case of claim 3, wherein the carrying case includes a plurality of compartments.
